(19) United States
(12) Patent Application Publication
(10) Pub. No.: US 2014/0152137 A1
(43) Pub. Date: Jun. 5, 2014

(54) MOTOR WITH VARIABLE MAGNET FLUX

(71) Applicant: NEW MOTECH CO., LTD., Gwangju (KR)

(72) Inventors: Jeong Cheol JANG, Gwangju (KR); Je Hyung SEO, Gwangju (KR); Soo Hyun PARK, Gwangju (KR); Woon Pil JUNG, Sunchun-si (KR); Hugh Jin CHO, Gwangju (KR); Seung Jae LEE, Gwangju (KR); Byung Taek KIM, Gunsan-si (KR); Jin Seok JANG, Gimje-si (KR)

(73) Assignee: NEW MOTECH CO., LTD., Gwangju (KR)

(21) Appl. No.: 14/042,742

(22) Filed: Oct. 1, 2013

(30) Foreign Application Priority Data
Dec. 3, 2012 (KR) 10-2012-0139159

(51) Int. Cl. H02K 1/27

(52) U.S. Cl. CPC H02K 1/2786
USPC 310/156.12

(57) ABSTRACT

Disclosed therein is a motor with a variable magnetic flux, which includes a rotor and a stator located inside the rotor. The rotor includes a rotor housing, a rotor core attached to the inner circumference of the rotor housing, and magnets attached to the inner surface of the rotor core. The stator includes a stator core base and a plurality of teeth radially formed on the outer peripheral surface of the stator core base at equal intervals, and each of the teeth has ears formed at both sides of an end thereof. The magnets are divided into first magnets and second magnets, the second magnets are low in coercive force than the first magnets, and a plurality of the first magnets are located at both sides of the second magnets.

### BACKGROUND OF THE INVENTION

1. Field of the Invention

The present invention relates to a motor. More particularly, the present invention relates to a new structure of a motor, which can be operated at a variable speed by demagnetizing or magnetizing some of magnets applied to a rotor and can obtain high efficiency by concentrating an amount of magnetic flux.

2. Background Art

In general, in order to simultaneously obtain a variable speed operation and high efficiency of a motor, various structures and forms of motors have been proposed. Representatively, there are a variable flux memory motor (VFMM) (hereinafter, called “prior art 1”) and a motor disclosed in Japanese Patent Laid-open No. 2009-112454 (hereinafter, called “prior art 2”).

A rotor of the variable flux memory motor according to the prior art 1 is basically similar with a brushless DC electric motor (BLDC motor) of a spoke type. The motor is a motor that permanent magnets are demagnetized from a narrower part thereof due to a difference in thickness of the permanent magnets when a negative d-axis current flows to a d-axis which is a magnetic flux generation axis of a stator. The motor is operated at a variable speed by demagnetizing and magnetizing the permanent magnets based on the above principle.

The motor according to the prior art 2 is basically similar with an outer-rotor type BLDC motor of a salient pole concentrated winding structure. The motor is characterized in that two kinds of magnets with different coercive forces are embedded in a rotor core in such a way as to be arranged in a circumferential direction in turn to thereby form opposite poles. That is, the rotor core has holes for embedding a first magnet and a second magnet therein and protrusions formed on an inner face of the rotor core. Accordingly, the motor according to the prior art 2 has several problems in that the rotor core is complicated in structure and manufacturing costs are increased. Particularly, the first magnet is a neodymium (Nd) magnet, and it is the factor in an increase of manufacturing costs.

In order to solve the above problems of the prior arts, the inventors of the present invention propose a new structure of a motor that includes: a rotor having a structure similar with the form of the existing SPM (Surface Permanent Magnet) motor; and a stator of a salient pole concentrated winding structure to thereby concentrate an amount of magnetic flux, to cause a high performance enhancement, and to reduce manufacturing costs.

### SUMMARY OF THE INVENTION

Accordingly, the present invention has been made to solve the above-mentioned problems occurring in the prior arts, and it is an object of the present invention to provide a motor with a variable magnetic flux of a new structure.

The above and other objects, features and advantages of the present invention will be apparent from the following detailed description of the preferred embodiments of the invention.

To achieve the above objects, the present invention provides a motor with a variable magnetic flux, which includes a rotor and a stator located inside the rotor, wherein the rotor includes a rotor housing, a rotor core attached to the inner circumference of the rotor housing, and magnets attached to the inner surface of the rotor core, the stator includes a stator core base and a plurality of teeth radially formed on the outer peripheral surface of the stator core base at equal intervals, and each of the teeth has ears formed at both sides of an end thereof, and the magnets are divided into first magnets and second magnets, the second magnets are low in coercive force than the first magnets, and a plurality of the first magnets are located at both sides of the second magnets.

In the present invention, the first magnets are ferrite magnets and the second magnets are alnico magnets.

In the present invention, the rotor core is formed by a plurality of unit rotor cores connected with each other.

In the present invention, laser welding lines are formed at both sides of the unit rotor core.

In the present invention, at least one first combining groove is vertically formed on the outer surface of the unit rotor core.

In the present invention, at least one second combining groove is vertically formed on the inner surface of the unit rotor core.

The variable magnetic flux motor according to the present invention is simple in structure, and can reduce manufacturing costs and cause a high performance enhancement because it is favorable to concentration of the amount of magnetic flux.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a plan view of a structure of a rotor of a motor with a variable magnetic flux according to the present invention;

FIG. 2 is a perspective view of a rotor structure of the motor with the variable magnetic flux according to the present invention;

FIG. 3 is a perspective view of a unit rotor core used in the rotor of the motor with the variable magnetic flux;

FIG. 4 is a perspective view of a stator of the motor with the variable magnetic flux;

FIG. 5 is a plan view of the stator of the motor with the variable magnetic flux;

FIG. 6 is a conceptual view for explaining a change in magnetic flux of the motor;

FIG. 7 is a graph showing a counter electromotive force in a magnetized state when the motor with the variable magnetic flux is in a no-load operation;

FIG. 8 is a graph showing a counter electromotive force in a demagnetized state when the motor with the variable magnetic flux is in a no-load operation;

FIG. 9 is a graph showing a torque characteristic when the motor with the variable magnetic flux according to the present invention is operated at low speed;

FIG. 10 is a graph showing a torque characteristic when the motor with the variable magnetic flux according to the present invention is operated at high speed; and

FIG. 11 is a graph showing a torque characteristic when the motor with the variable magnetic flux according to the present invention is operated at another low speed.

Hereinafter, reference will be now made in detail to the preferred embodiment of the present invention with reference to the attached drawings.

### DETAILED DESCRIPTION OF THE PREFERRED EMBODIMENT

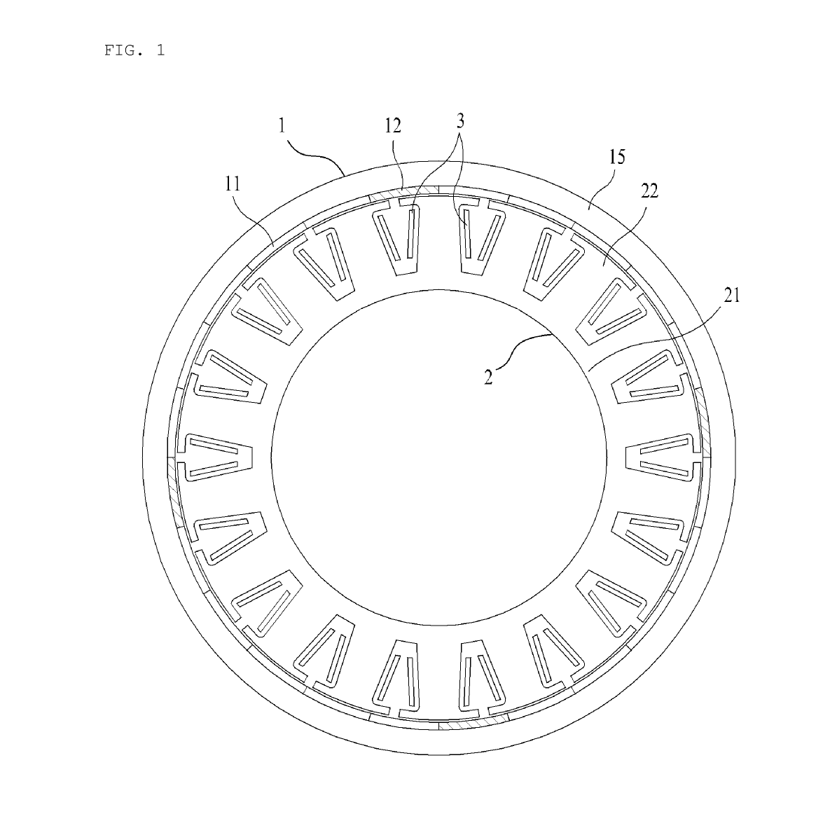

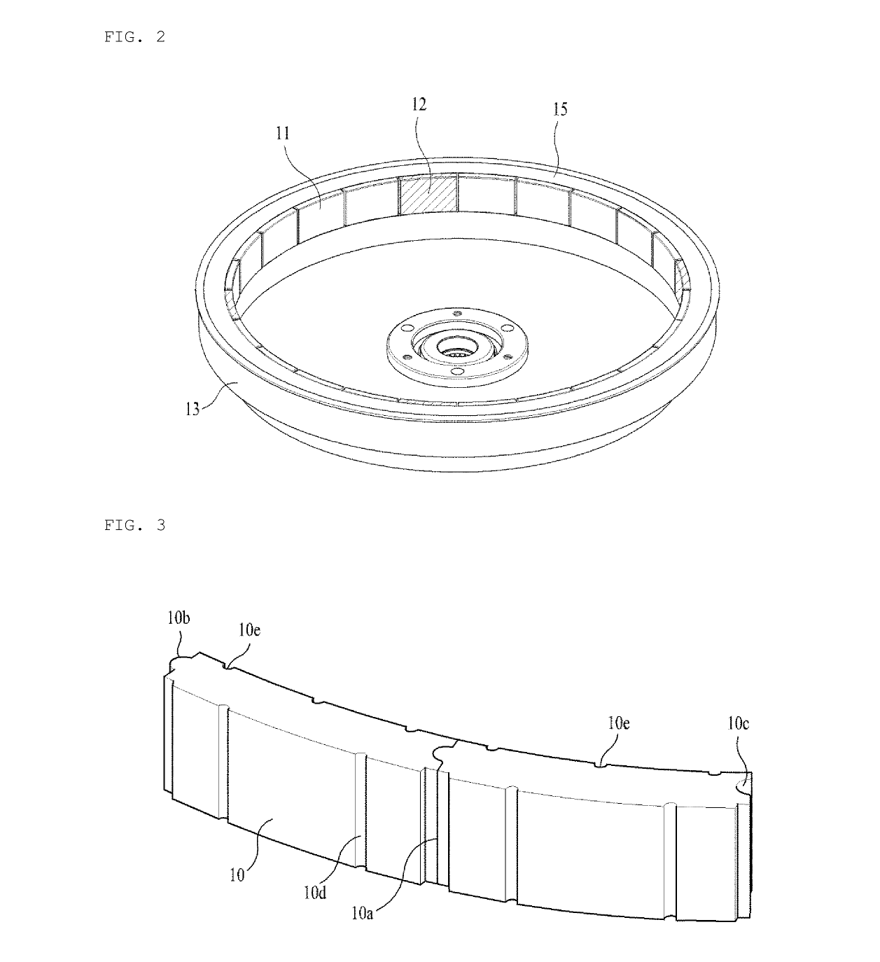

FIG. 1 is a plan view of a structure of a variable magnetic flux motor according to the present invention, and FIG. 2 is a perspective view of a structure of a rotor of a variable magnetic flux motor according to the present invention.

As shown in FIG. 1, the variable magnetic flux motor according to the present invention includes a rotor 1 and a stator 2.

The rotor 1 includes a plurality of unit rotor cores 10, first magnets 11, and second magnets 12, which are located on the outer circumferential surface of the stator 2. As shown in FIG. 2, the first magnets 11 and the second magnets 12 are located inside the rotor core 15, and a rotor housing 13 surrounds the outside of the rotor core 15.

In the present invention, the stator 2 includes a stator core base 21 and a plurality of teeth 22 radially formed on the outer peripheral surface of the stator core base 21.

A coil 3 is wound on the teeth 22 of the stator 2, and occupies some space in a slot formed between two neighboring teeth 22.

As shown in FIGS. 1 and 2, the motor according to the present invention adopts a type of 24 poles-18 slots, but the present invention is not limited to the above, and on occasion demands, the number of poles and slots may be varied.

In the case of the motor with 24 poles-18 slots, as shown in FIG. 1, twenty-four magnets 11 and 12 are located inside the rotor core 15. Out of the twenty-four magnets, twenty magnets are the first magnets 11 and four magnets are the second magnets 12. That is, the motor has a structure that one second magnet 12 is mounted at one side of the five first magnets 11.

The rotor core 15 is made of a metallic material, and the first magnets 11 and the second magnets 12 are attached on the inner surface of the rotor core 15. As shown in FIGS. 1 and 2, the entire of the rotor core 15 may be made of one material, or one rotor core 15 may be made by a plurality of unit rotor cores 10 connected with each other. Referring to FIG. 3, the unit rotor cores 10 will be described in detail.

Preferably, in the present invention, the first magnets 11 are ferrite magnets, and the second magnets 12 are alnico magnets. Rotational characteristic of the motor can be regulated using a difference in coercive force between the first and second magnets of the two kinds. That is, an amount of magnetic flux of the second magnets 12 is regulated using magnetizing current and demagnetizing current, so as to control output, torque and RPM characteristics of the motor as occasion demands.

FIG. 3 is a perspective view of the unit rotor core 10 forming the rotor core 15 of the motor the variable magnetic flux according to the present invention. In FIG. 3, two unit rotor cores 10 are joined.

As shown in FIG. 3, the unit rotor core 10 according to the present invention has a structure that another unit rotor core 10 can be attached to both sides thereof, and a plurality of the unit rotor cores 10 are attached so as to form a circular rotor core 15. That is, when a plurality of unit rotor cores are repeatedly attached, it generally forms a circular shape. In order to attach one unit rotor core to the neighboring unit rotor core, a welding line 10a may be formed at both sides of the unit rotor core 10. The unit rotor core can be joined to the neighboring unit rotor core by laser welding along the welding line 10a. Of course, the attachment method is not limited to the laser welding, and may be adopted from various attachment methods. For instance, caulking, compression or other welding methods may be applied. In order to increase joining force along the welding line 10a, it is also possible that a joining protrusion 10b is formed at one side of the unit rotor core 10 and a joining groove 10c is formed at the other side of the unit rotor core 10, so that the neighboring unit rotor cores can be easily joined.

At least one first combining groove 10d may be vertically formed on the outer face of the unit rotor core 10. The first combining groove 10d can increase an adhesive force of the rotor core 15 and the rotor housing 13 because an adhesive agent is put in through the first combining groove 10d when the rotor core 15 formed by the unit rotor cores 10 is adhered to the rotor housing 13 by the adhesive agent. Moreover, at least one second combining groove 10e may be vertically formed on the inner face of the unit rotor core 10 so as to increase the adhesive force when the first and second magnets 11 and 12 joined into the rotor core 15 are adhered by the adhesive agent.

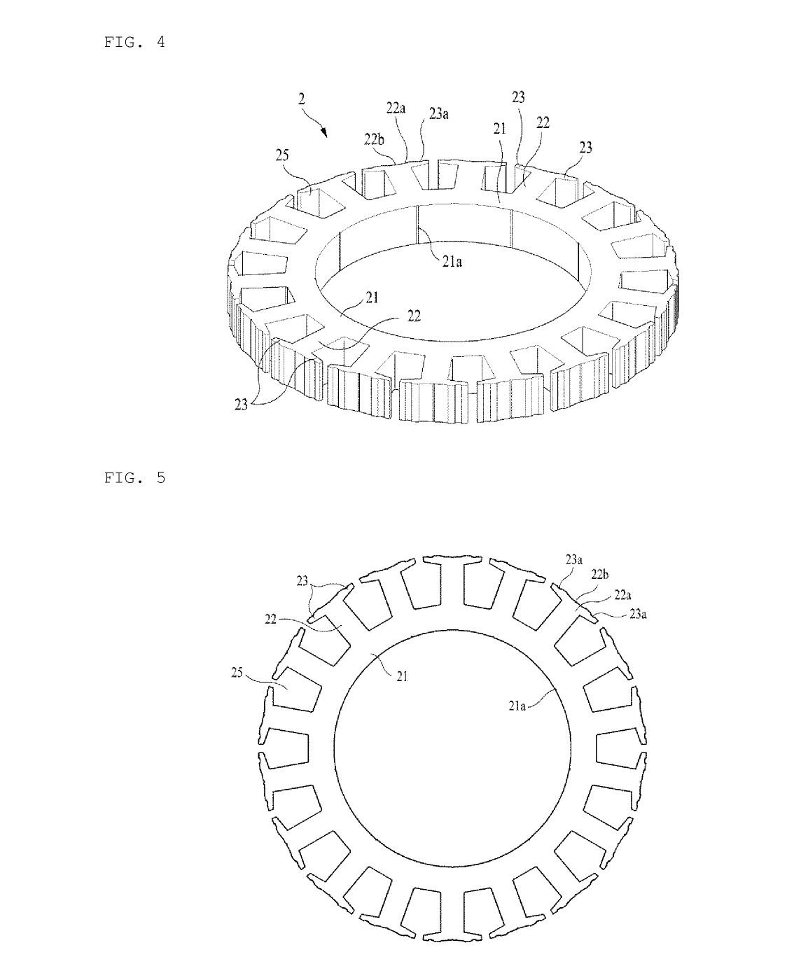

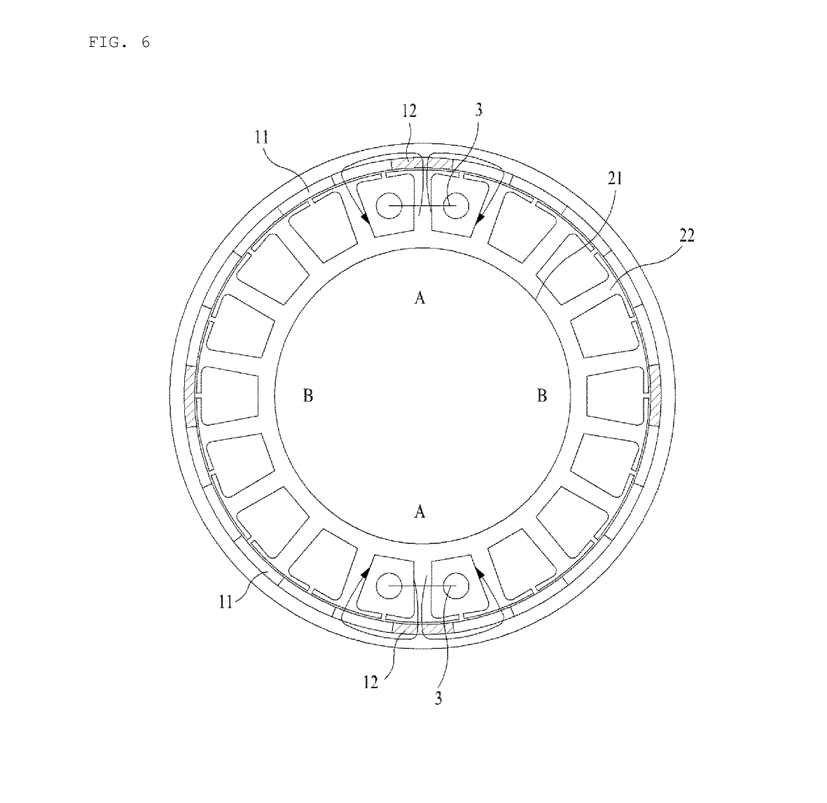

FIG. 4 is a perspective view of the stator 2 of the motor with the variable magnetic flux, and FIG. 5 is a plan view of the stator 2 of the motor with the variable magnetic flux.

As shown in FIGS. 4 and 5, the stator 2 according to the present invention includes the circular stator core base 21, and the teeth 22 radially arranged on the outer circumferential surface of the stator core base 21 at equal intervals. Each of the teeth 22 has ears 23 formed at both sides of an end thereof. The stator 2 is generally formed by core steel sheets laminated repeatedly. The stator core base 21 has a plurality of base welding slots 21a formed on the inner circumferential surface thereof, and laser welding is carried out along the base welding slots 21a so as to firmly fix a plurality of the core steel sheets. Of course, besides the laser welding, caulking or other welding method may be applied.

The space formed between the two neighboring teeth 22 forms a slot 25. The coil is wound on the teeth 22. In order to electrically insulate between the teeth 22 and the coil 3 before the coil is wound, an insulator (not shown) may be wrapped on the teeth 22. Each of the teeth 22 has a tooth recess 22a inwardly hollowed a little and formed on the outer peripheral surface of the end portion thereof, and each of the ears 23 formed at both sides of the end of the tooth 22 also has an ear recess 23a inwardly hollowed a little similarly with the tooth recess 22a. The tooth recess 22a and the ear recess 23a serve to reduce a cogging torque which can concentrically generate the amount of magnetic flux.

The tooth recess 22a has a tooth welding slot 22b, and the tooth welding slot 22b serves to combine the stator core sheets together through one of various welding methods like the base welding slots 21a which are described previously.

FIG. 6 is a conceptual view for explaining a change in magnetic flux of the variable magnetic flux motor.

Referring to FIG. 6, at the part A of the stator, the second magnets 12 which are the alnico magnets are arranged on a d-axis, and then, the magnetizing current flows to magnetize the second magnets. On the contrary, in order to demagnetize, in the same way as the magnetization, the second magnets 12 are arranged on the d-axis, and then, a negative(−) d-axis current flows in the opposite direction to the direction of a magnetomotive force. Furthermore, in the case that it is impossible to simultaneously demagnetize the parts A and B of FIG. 1, a pair of the magnets of the part A are demagnetized at once, and then, a pair of the magnets of the part B are demagnetized.

### Embodiment

In order to analyze demagnetization characteristic of the variable magnetic flux motor according to the present invention, the finite element analysis (FEA) was applied. After the motor with 24 poles-18 slots was manufactured, the FEA was applied under various analyzing conditions.

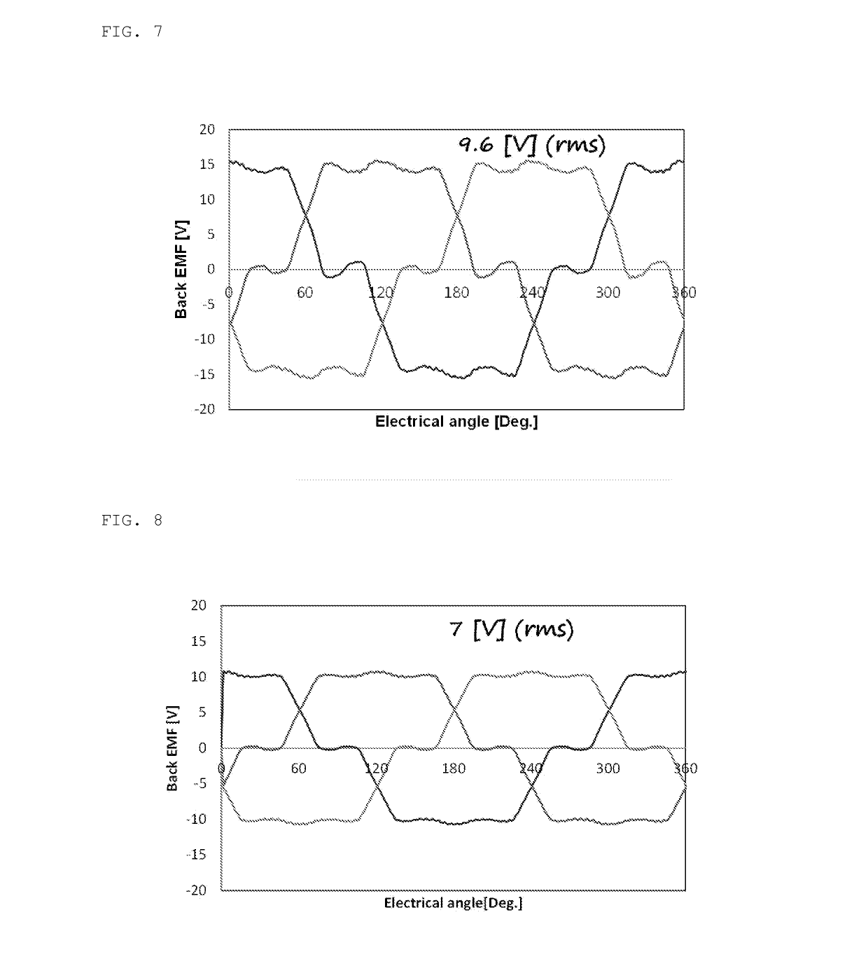

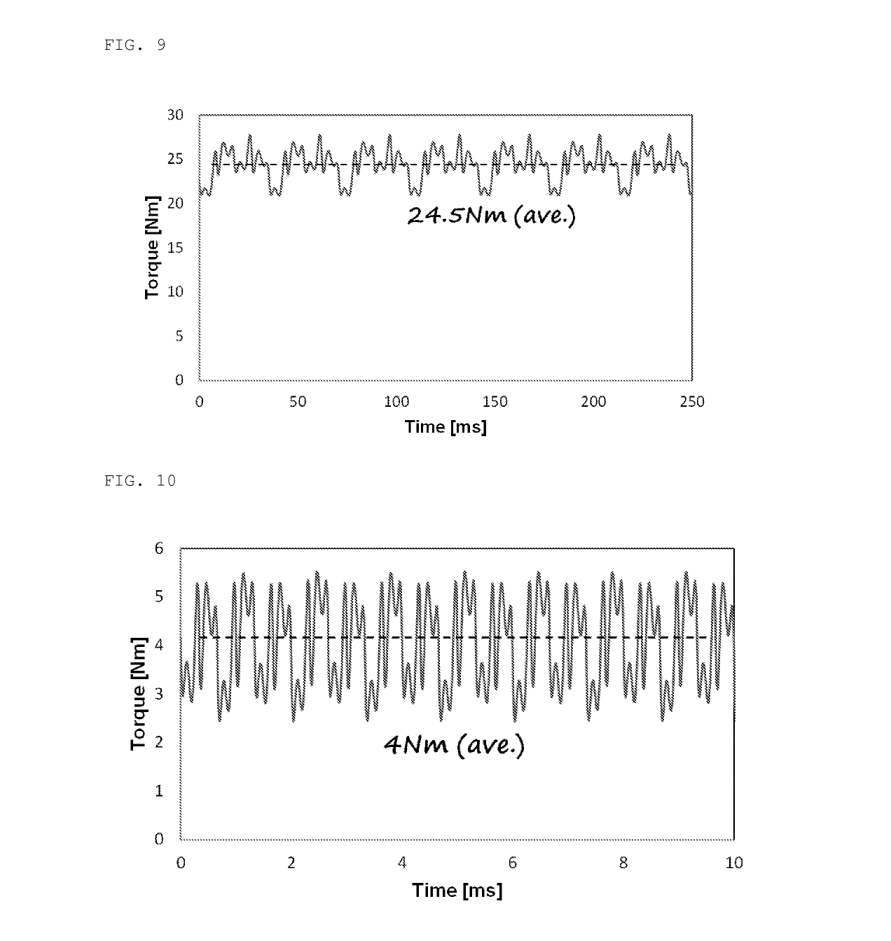

First, under a no-load operation, a counter electromotive force at 45 rpm in full magnetization of the alnico magnets was measured, and after that, the counter electromotive force was measured after the motor was operated at 45 rpm in a state where the alnico magnets were demagnetized. The measurement results were illustrated in FIGS. 7 and 8. FIG. 7 illustrates the measurement result at the time of the full magnetization of the alnico magnets and FIG. 8 illustrates the measurement result at the time of demagnetization of the alnico magnets.

As shown in FIGS. 7 and 8, the counter electromotive force at the time of full magnetization and the counter electromotive force at the time of demagnetization were compared with each other, and then, it was estimated whether or not a variable magnetic flux was possible. As a result, the counter electromotive force at the time of full magnetization was 9.6V and the counter electromotive force at the time of demagnetization was 7V, and hence, variable magnetic flux of about 27% was possible.

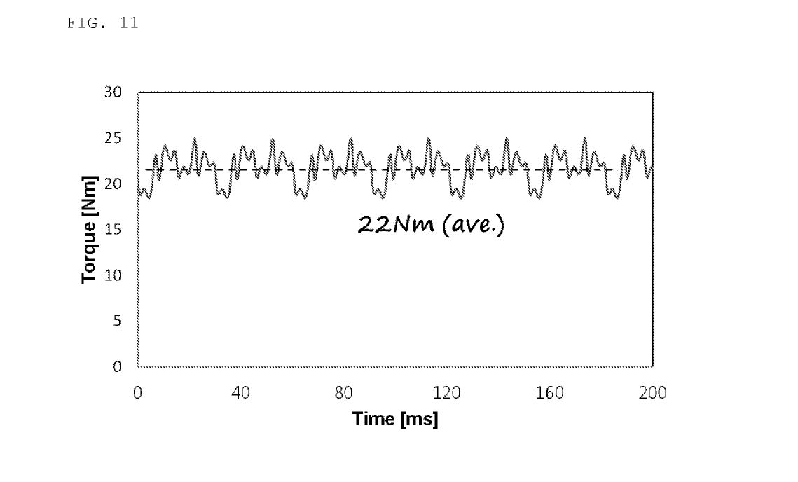

Next, in order to analyze operation characteristics at low speed, torque during operation was estimated at 47 rpm and 1250 rpm. FIG. 9 illustrates torque characteristics under the low speed operation, and FIG. 10 illustrates torque characteristics under the high speed operation. The average torque was 24.5 Nm during the low speed operation but was 4 Nm during the high speed operation. FIG. 11 is a graph showing torque values when the operation speed was 55 rpm.

While the present invention has been particularly shown and described with reference to the preferable embodiment thereof, it will be understood by those of ordinary skill in the art that the present invention is not limited to the above embodiment and various changes or modifications may be made therein without departing from the technical idea of the present invention.

What is claimed is:

1. A motor with a variable magnetic flux, which includes a rotor and a stator located inside the rotor,
wherein the rotor comprises a rotor housing, a rotor core attached to the inner circumference of the rotor housing, and magnets attached to the inner surface of the rotor core,
wherein the stator comprises a stator core base and a plurality of teeth radially formed on the outer peripheral surface of the stator core base at equal intervals, and each of the teeth has ears formed at both sides of an end thereof, and
wherein the magnets are divided into first magnets and second magnets, the second magnets are low in coercive force than the first magnets, and a plurality of the first magnets are located at both sides of the second magnets.

2. The motor according to claim 1, wherein the first magnets are ferrite magnets and the second magnets are alnico magnets.

3. The motor according to claim 1, wherein the rotor core is formed by a plurality of unit rotor cores connected with each other.

4. The motor according to claim 3, wherein laser welding lines are formed at both sides of the unit rotor core.

5. The motor according to claim 3, wherein at least one first combining groove is vertically formed on the outer surface of the unit rotor core.

6. The motor according to claim 3, wherein at least one second combining groove is vertically formed on the inner surface of the unit rotor core.
